(19) United States
(12) Patent Application Publication
(10) Pub. No.: US 2010/0020357 A1
(43) Pub. Date: Jan. 28, 2010

(54) Image Outputting Apparatus

(75) Inventor: Tomoyuki Amino, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/507,716

(22) Filed: Jul. 22, 2009

(30) Foreign Application Priority Data
Jul. 24, 2008 (JP) 2008-190461

(51) Int. Cl. G06F 3/12

(52) U.S. Cl. 358/1.15

(57) ABSTRACT

An image outputting apparatus includes: a consumables residual quantity detecting unit which detects a residual quantity of consumables; a job attribute determining unit which determines a job attribute of a print output job; and an output availability determining unit which determines whether a print output is available, wherein the output availability determining unit performs a first determining process of determining whether to perform only the print output or to perform the print output while storing the print output job data in accordance with the job attribute determined by the job attribute determining unit, when the consumables residual quantity detecting unit detects that the residual quantity of the consumables is equal to or less than a predetermined quantity.

### BACKGROUND

1. Technical Field

The present invention relates to a scanning apparatus, a copy apparatus, a facsimile apparatus, or a digital multi-function apparatus including a scanner unit and a printer unit, and particularly to an image outputting apparatus capable of performing print output in accordance with a use status of consumables.

2. Related Art

In known image outputting apparatuses such as an electro-photographic copy apparatus, an electro-photographic printer, an electro-photographic facsimile, an ink jet printer, and an ink jet multi-function apparatus, a cartridge filled with consumables such as toner or ink is detachably mounted. In addition, when the toner or the ink is used up, the cartridge is replaced by a new cartridge to supply consumables to the image outputting apparatus. In such an image outputting apparatus, as well as the consumables as a material for directly forming an image, consumables such as a photosensitive member can also be treated as the consumables in a broad sense of the term that the consumables have a predetermined endurance period.

As for the consumables, there is a need to guarantee a print output result by instantly replacing the consumables when the residual quantity of the consumables is uncertain. On the other hand, there is also a need to use the consumables as long as possible until the residual quantity of the consumables is used up. In order to meet this need, there has been suggested a technique for continuing to perform print output by continuously using the consumables even when the consumables have been used to some extent.

For example, JP-A-2005-121931 discloses a printing apparatus which performs a printing process by use of consumables and includes an input unit which receives an instruction from a user, an index value calculating unit which calculates an index value indicating the degree to which the consumables have been used, a consumables status determining unit which distinguishes a first status in which the quantity of the consumables used is small from a second status in which a certain quantity of the consumables has been used on the basis of the index value, and a control unit which enables the printing process to continue when the instruction is received from the input unit even upon shifting the consumption status of the consumables from the first status to the second status.

However, the technique disclosed in JP-A-2005-121931 has a problem in that even a print output job considered to be important by a user that wants to continuously print a high quality image is subjected to a low quality printing process due to an insufficient quantity of the consumables when the instruction is received from the input unit upon shifting the consumption status of the consumables from the first status to the second status and the printing process continues to be performed.

In particular, when the image outputting apparatus is a facsimile apparatus, data once used to perform the print output on a sheet are erased. Therefore, when the low quality printing process is performed due to the insufficient quantity of the consumables and thus the print result cannot be read, a problem occurs in that a troublesome work of contacting the sender and again requesting the facsimile transmission has to be carried out.

### SUMMARY

According to an aspect of the invention, there is provided an image outputting apparatus including: a consumables residual quantity detecting unit which detects a residual quantity of consumables; a job attribute determining unit which determines a job attribute of a print output job; and an output availability determining unit which determines whether a print output is available. The output availability determining unit performs a first determining process of determining whether to perform only the print output or to perform the print output while storing the print output job data in accordance with the job attribute determined by the job attribute determining unit, when the consumables residual quantity detecting unit detects that the residual quantity of the consumables is equal to or less than a predetermined quantity.

The image outputting apparatus according to this aspect of the invention may further include a mail transmitting unit which appends data associated with the print output job to a mail and transmits the mail. The output availability determining unit performs a second determining process of determining whether to perform only the print output or to perform the print output while transmitting the mail having the data associated with the print output job by the mail transmitting unit in accordance with the job attribute determined by the job attribute determining unit, when the consumables residual quantity detecting unit detects that the residual quantity of the consumables is equal to or less than the predetermined quantity.

The image outputting apparatus according to this aspect of the invention may further include a consumables endurance expectancy calculating unit which calculates an endurance expectancy of consumables. The output availability determining unit performs a third determining process of determining whether to perform only the print output or to perform the print output while storing the print output job data in accordance with the job attribute determined by the job attribute determining unit, when the consumables endurance expectancy calculating unit detects that the endurance expectancy of the consumables is equal to or less than a predetermined expectancy.

In the image outputting apparatus according to this aspect of the invention, the output availability determining unit may perform a fourth determining process of determining whether to perform only the print output or to perform the print output while transmitting the mail having the data associated with the print output job by the mail transmitting unit in accordance with the job attribute determined by the job attribute determining unit, when the consumables endurance expectancy calculating unit detects that the endurance expectancy of the consumables is equal to or less than the predetermined expectancy.

The image outputting apparatus according to this aspect of the invention may further include a print output counting unit which counts the print output. The output availability determining unit may perform the first to fourth determining processes in accordance with the result counted by the print output counting unit and the job attribute determined by the job attribute determining unit.

In the image outputting apparatus according to this aspect of the invention, the job attribute determining unit may make the determination in accordance with one or a combination of an attribute associated with the sender of the print output job, an attribute associated with an image quality of the print output job, and an attribute associated with a color of the print output job.

In the image outputting apparatus according to this aspect of the invention, when the consumables residual quantity detecting unit detects that the residual quantity of the consumables is equal to or less than the predetermined quantity or the consumables endurance expectancy calculating unit detects that the endurance expectancy of the consumables is equal to or less than the endurance expectancy, a so-called data backup is carried out for the print output job which is determined to be important by the job attribute determining unit, by performing the print output while storing the print output job data or by performing the print output while transmitting the data associated with the print output job by the electronic mail. Accordingly, even when a low quality printing process is performed due to the insufficient quantity of the consumables and thus the print result cannot be read, it is possible to again perform the printing process on the basis of the backup data and prevent the problem that the facsimile transmission has to be again requested by contacting the sender.

### BRIEF DESCRIPTION OF THE DRAWINGS

The invention will be described with reference to the accompanying drawings, wherein like numbers reference like elements.

FIG. 1 is a diagram illustrating the system configuration of an image outputting apparatus (multi-function apparatus) and the peripherals according to an embodiment of the invention.

FIGS. 2A and 2B are diagrams illustrating an example of a method of detecting a residual quantity of consumables and a method of calculating an endurance expectancy of consumables.

FIG. 3 is a flowchart illustrating an image outputting process performed by the image outputting apparatus according to this embodiment of the invention.

FIG. 4 is a diagram for explaining flags and counters used in each flowchart of each process of the image outputting apparatus according to this embodiment of the invention.

FIG. 5 is a flowchart illustrating a sub-routine of a consumables replacement detecting process of the image outputting apparatus according to this embodiment of the invention.

FIG. 6 is a flowchart illustrating a sub-routine of a residual quantity check process of the image outputting apparatus according to this embodiment of the invention.

FIGS. 7A and 7B are flowcharts illustrating a sub-routine of an output possibility determining process of the image outputting apparatus according to this embodiment of the invention.

FIG. 8 is a flowchart illustrating a sub-routine of a counting process of counters (M, N) performed by the image outputting apparatus according to this embodiment of the invention.

FIG. 9 is a diagram illustrating a display example in the operation panel unit of the image outputting apparatus (the multi-function apparatus) according to this embodiment of the invention.

FIG. 10 is a diagram illustrating a display example in the operation panel unit of the image outputting apparatus (the multi-function apparatus) according to this embodiment of the invention.

FIG. 11 is a diagram illustrating a display example in the operation panel unit of the image outputting apparatus (the multi-function apparatus) according to this embodiment of the invention.

FIG. 12 is a diagram illustrating a classification example of job attributes in the image outputting apparatus (the multi-function apparatus) according to this embodiment of the invention.

FIG. 13 is a diagram illustrating the system configuration of an image outputting apparatus (multi-function apparatus) and the peripherals according to another embodiment of the invention.

FIG. 14 is a flowchart illustrating a sub-routine of an output possibility determining process of the image outputting apparatus according to the another embodiment of the invention.

### DESCRIPTION OF EXEMPLARY EMBODIMENTS

Hereinafter, an embodiment of the invention will be described with reference to the drawings. In this embodiment, a multi-function apparatus is exemplified as an image outputting apparatus. The invention is not limited to the multi-function apparatus, but may be applied to an image outputting apparatus such as a copy apparatus or a printing apparatus as a single apparatus.

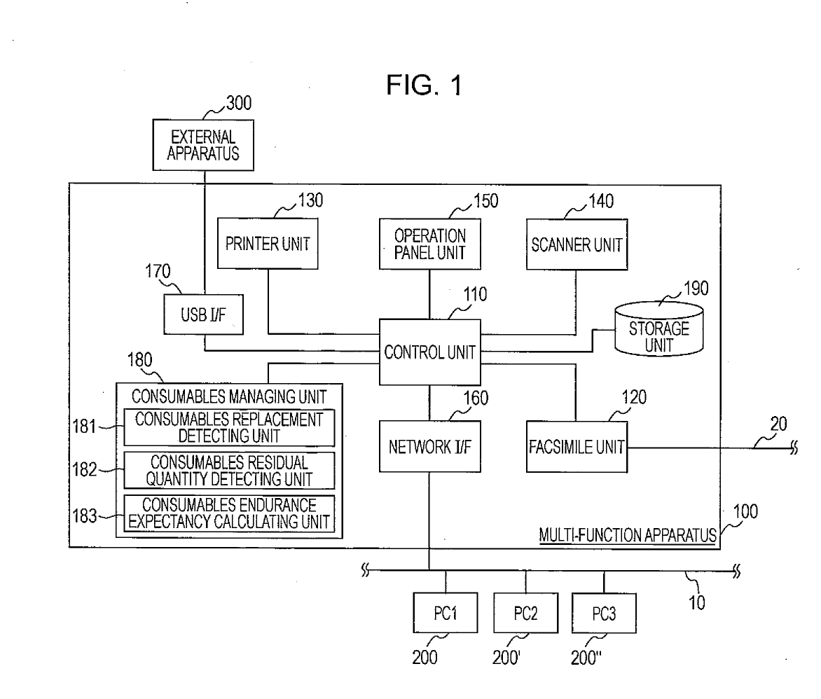

FIG. 1 is a diagram illustrating the system configuration of a facsimile apparatus (multi-function apparatus) and the peripherals according to the embodiment of the invention. In FIG. 1, Reference Numeral 10 denotes a network such as LAN or WAN. Reference Numeral 20 denotes a telephone line. Reference Numeral 100 denotes the multi-function apparatus. Reference Numeral 110 denotes a control unit of the multi-function apparatus which performs main controlling. Reference Numeral 120 denotes a facsimile unit which transmits or receives a facsimile document. Reference Numeral 130 denotes a printer unit which prints an image on a record medium. Reference Numeral 140 denotes a scanner unit which reads a document. Reference Numeral 150 denotes an operation panel unit which serves as an interface with a user. Reference Numeral 160 denotes a network I/F. Reference Numeral 170 denotes a USB I/F. Reference Numeral 180 denotes a consumables managing unit. Reference Numeral 181 denotes a consumables replacement detecting unit. Reference Numeral 182 denotes a consumables residual quantity detecting unit. Reference Numeral 183 denotes a consumables endurance expectancy calculating unit. Reference Numeral 190 denotes a storage unit. Reference Numerals 200, 200′, and 200″ denote personal computers. Reference Numeral 300 denotes an external apparatus.

A system in the vicinity of the image outputting apparatus (multi-function apparatus) shown in FIG. 1 includes the personal computers 200, 200′, and 200″ such as clients and the multi-function apparatus 100 which are connected to each other through the network 10. The facsimile unit 120 of the multi-function apparatus 100 is connected to the telephone line 20 and the USB I/F 170 is connected to the external apparatus 300 such as a cellular phone or a digital camera.

The multi-function apparatus 100 includes the control unit 110 which is configured as an information processing unit and mainly controls the multi-function apparatus, the operation panel unit 150 which is an input and output unit receiving an input operation of a user, the scanner unit 140 which scans an image of a document and reads the colors of the image, the printer unit 130 which prints an image on a print sheet, and a facsimile unit 120 which performs facsimile transmission and reception. That is, the multi-function apparatus 100 includes a scanning function, a printing function, a copy function made by combining the scanning function and the printing function, and a facsimile transmission and reception function.

All information processing mechanisms of the multi-function apparatus 100 are configured by a general-purpose computer system, for example. Respective constituent elements or functions are realized by executing computer programs stored in a storage unit, for example.

The scanner unit 140 includes a document table (not shown) on which a document can be placed and an optical system which reads the placed document. The document table of the scanner unit 140 is provided with a document size detecting sensor which can detect the size of the document placed on the document table. The multi-function apparatus 100 is provided with an automatic document feeder (ADF) which continuously feeds documents to the scanner unit 140 in an automatic manner.

Document image data read by the scanner unit 140 are once stored in a storage unit (not shown) of the control unit 110. By designation from the operation panel unit 150, the control unit 110 outputs the document image data read by the scanner unit 140 from the printer unit 130 on a print sheet without change or with change in a set magnification ratio (the copy function of the multi-function apparatus 100), allows the facsimile unit 120 to transmit the document image data through the telephone line (the facsimile function of the multi-function apparatus 100), or transmits the document image data to the personal computers 200, 200′, and 200″ through the network I/F 160 and the network 10 (the scanning function of the multi-function apparatus 100).

The printer unit 130 forms an image on the print sheet and can use a known hardware configuration for using an electrographic method of forming a latent image on a photosensitive member by a laser or LED line head or for using an ink jet method of directly ejecting ink on the print sheet. The control unit 110 allows the printer unit 130 to output data on the print sheet on the basis of an instruction from the operation panel unit 150, the personal computer 200, 200′, or 200″, or the external apparatus 300 such as a cellular phone or a digital camera. That is, the printer unit 130 outputs image data read by the scanner unit 140, facsimile data received from the facsimile unit 120, data from the application software of the personal computer 200, 200′, or 200″, or image data from the external apparatus 300 on the print sheet.

The facsimile unit 120 is connected to the telephone line 20 and includes a facsimile transceiver (not shown) which performs the facsimile transmission and reception and a facsimile memory which is constituted by a transmitting buffer temporarily storing transmission data to be transmitted by the facsimile transceiver and a receiving buffer temporarily storing reception data received by the facsimile transceiver.

The facsimile unit 120 first stores the reception data, when the facsimile unit 120 receives the data facsimile-transmitted from the telephone line 20. The stored reception data are sent to the control unit 110 and printed by the printer unit 130. The facsimile unit 120 performs the facsimile transmission and reception independently from the other configuration of the multi-function apparatus 100. That is, when the facsimile unit 120 receives the transmission data from the multi-function apparatus 100, the facsimile unit 120 performs the facsimile transmission independently from the multi-function apparatus 100. In addition, when the facsimile unit 120 receives the facsimile data through the telephone line 20, the facsimile unit 120 receives the facsimile data.

The copy function of the multi-function apparatus 100 is set in the control unit 110 by the operation of the operation panel unit 150 by the user. The copy function can be carried out and setting of a copy magnification related to the copy function, setting of the size of a document image, and setting of the size of the print sheet can be carried out by the operation panel unit 150. The control unit 110 carries out the copy function of the multi-function apparatus 100 on the basis of these settings. The copy function of the multi-function apparatus 100 is a function of processing the copy magnification ratio of the document image data of the document read by the scanner unit 140 and outputting the document image data on the print sheet having a designated size by the printer unit 130.

The hardware of the operation panel unit 150 generally includes a display unit configured by an LCD making a display related to an operation and a touch panel unit performing an input operation by pressing of a finger or the like. The display unit and the touch panel unit are formed so as to overlap with each other. The user operates the touch penal with a finger to perform various kinds of setting on the multi-function apparatus 100 with reference to the display of the display unit. The details of an input mechanism of the touch panel unit and a display mechanism of the display unit can be configured by known techniques. What is carried out in the operation panel unit 150 is selection of various functions such as the facsimile function, the printing function, and the copy function of the multi-function apparatus 100, a preview display of an image, and the like.

Either in the electro-photographic type in which toner is used or in the ink jet type in which ink is used, the image outputting apparatus (the multi-function apparatus) 100 cannot output an image having a predetermined quality on the print sheet, when consumables which are image forming materials such as toner or ink or consumables such as a photosensitive member having an endurance period are not replaced at a proper time. The consumables managing unit 180 manages consumables (which include a photosensitive member, a transfer unit, and a development unit in the broad sense of the term) in an engine unit for forming the above-described image and includes the consumables replacement detecting unit 181, the consumables residual quantity detecting unit 182, and the consumables endurance expectancy calculating unit 183.

The consumables replacement detecting unit 181 includes a mechanical switch (not shown), for example, and detects replacement of the consumables. The consumables residual quantity detecting unit 182 detects the residual quantity of an image forming member such as a toner cartridge or an ink cartridge (not shown). The consumables endurance expectancy calculating unit 183 calculates the endurance expectancy of the consumables such as the photosensitive member, the transfer unit, and the development unit having an endurance period, that is, calculates how long the consumables can be used in future.

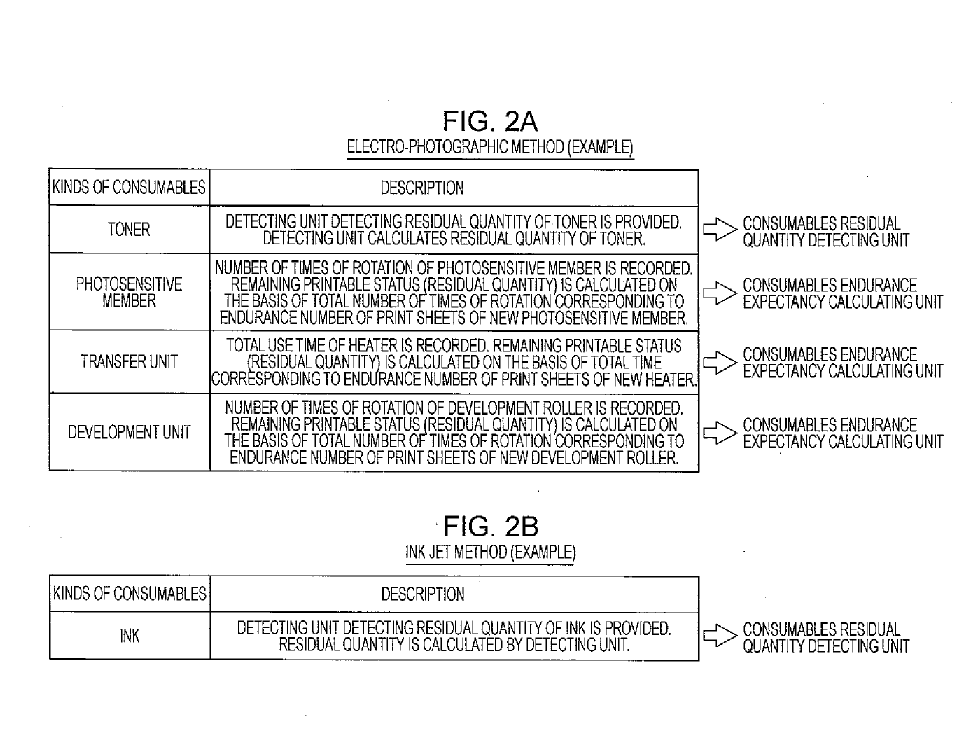

Here, FIGS. 2A and 2B show tables summarizing a method of calculating the residual quantity of toner and the endurance expectancy of consumables such as the photosensitive member, the transfer unit, and the development unit in the electro-photographic image outputting apparatus and a detailed method of detecting the residual quantity of ink in the ink jet image outputting apparatus. FIGS. 2A and 2B are diagrams illustrating the table summarizing the method of detecting the residual quantity of consumables and the method of calculating the endurance expectancy of consumables. The description of the methods of detecting the residual quantity and the method of calculating the endurance expectancy shown in FIGS. 2A and 2B is just an example. Various methods can be used in the image outputting apparatus according to the invention.

The consumables replacement detecting unit 181, the consumables residual quantity detecting unit 182, and the consumables endurance expectancy calculating unit 183 included in the consumables managing unit 180 can all be configured using known devices.

The storage unit 190 is a non-volatile memory such as a hard disk drive or a flash memory different from a storage unit provided in the control unit 110 and has a predetermined storage capacity or a storage capacity that exceeds the predetermined capacity. If necessary, the storage unit 190 has a configuration for storing facsimile reception data which have been transmitted.

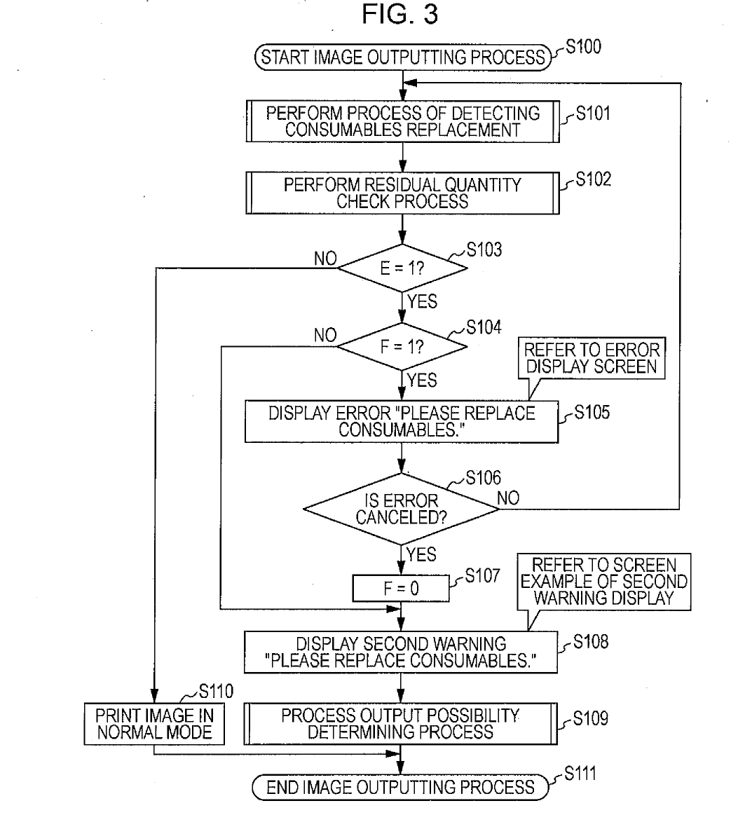

Next, an image outputting process performed by the image outputting apparatus.(the multi-function apparatus) 100 according to the invention will be described. FIG. 3 is a flowchart illustrating the image outputting process performed by the image outputting apparatus according to this embodiment of the invention. In the flowchart described below, it is assumed that consumables in the broad sense of the term are included.

The flowchart shown in FIG. 3 starts when the image outputting apparatus (the multi-function apparatus) 100 receives a print output job from the personal computer 200, 200′, or 200″ as a client or when a command for carrying out the copy function is generated from the operation panel unit 150 by the user. The flowchart shown in FIG. 3 may be started when the image outputting apparatus (the multi-function apparatus) 100 receives facsimile data and prints the received data. The flowchart shown in FIG. 3 is a flowchart for executing a process of carrying out the print out of the print output job (including a job of the copy function). A job executed in the image outputting apparatus (the multi-function apparatus) 100 has attributes described below.

In FIG. 3, when the image outputting process starts in step S100, the process then proceeds to step S101 to execute a sub-routine of a consumables replacement detecting process.

Subsequently, in step S102, a sub-routine of a residual quantity check process is executed

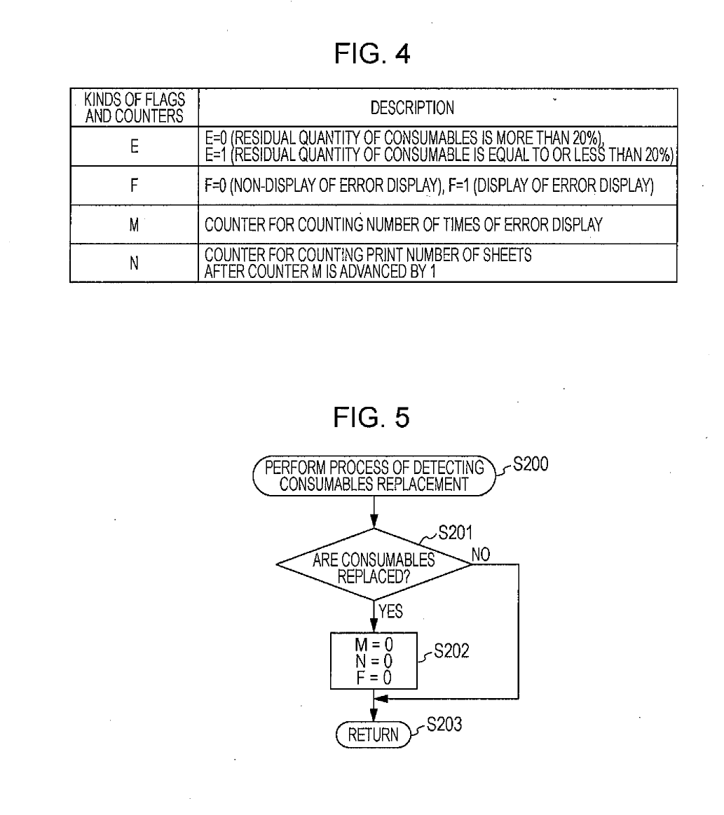

Subsequently, in step S103, it is determined whether E is equal to 1. Here, flags or counters used in the flowchart of the image outputting process according to the invention will be described. FIG. 4 is a diagram for explaining the meanings of the flags and the counters used in the flowchart of the image outputting process according to the embodiment of the invention. The flags and the counters are stored in a non-volatile storage unit even when the image outputting apparatus turns off.

E is a flag. When E=0, this flag means that the residual quantity of consumables is more than 20%. Alternatively, when E=1, E means that the residual quantity of consumables is equal to or less than 20%. In this embodiment, 20% is a reference point of the residual quantity of consumables, but any residual quantity of consumables may be used as the reference point.

F is a flag. When F=0, this flag means that an error display is not shown. Alternatively, when F=1, this flag means that error display is shown. In addition, the error display is shown in the operation panel unit 150.

M is a counter. This counter is a counter for counting the number of times the error display is shown.

N is a counter. This counter counts the print number of sheets after the counter M is advanced by 1.

Again, the process returns to the flowchart of FIG. 3. When the determination result of step S103 is NO, the process proceeds to step S110. That is because a sufficient residual quantity of consumables remains. In step S110, an image is printed in a normal mode. Subsequently, in step S111, the image outputting process ends. Alternatively, when the determination result of step S103 is YES, the process proceeds to step S104.

In step S104, it is determined whether the flag F satisfies the relation of F=1. This flag represents a display or a non-display of an error display, as described above.

When the determination result is NO in step S104, steps S105 to S107 (steps for making the error display) are skipped, and then the process proceeds to step S108. Alternatively, when the determination result is YES in step S104, the process proceeds to step S105 to make an error display.

In Step S105, an error display such as a message “Please replace consumables” is shown in the operation panel unit 150. Here, in the image outputting apparatus (the multi-function apparatus) 100 according to this embodiment, there are two kinds of alarms: “an error display” and “a warning display” as warning alarms for the user operating the operation panel unit 150. The warning alarm of the former display is more serious than the warning alarm of the latter display. The former display cannot be cancelled without an operation of the user operating the operation panel unit 150, but the latter display is shown together with other displays in the operation panel unit 150 and not required for a specific user to perform a canceling operation.

FIG. 10 is a diagram illustrating a display example in the operation panel unit of the image outputting apparatus (the multi-function apparatus) 100 according to this embodiment of the invention. As shown in FIG. 10, the error display “please replace consumables” is displayed as a pop-up menu in an overlap manner on the other displays. In addition, until a “cancellation” button is pressed down in the drawing or each of the consumables is actually replaced, this error display does not disappear.

In step S106, it is determined whether the “cancellation” button of FIG. 10 is pressed down by the user. When the determination result is YES in step S106, the process proceeds to step S107. Alternatively, when the determination result is NO, the process returns to step S101.

Steps S101 to S106 are looped until the “cancellation” button is pressed down or each of the consumables is effectively replaced in step S106. When each of the consumables is effectively replaced during this loop, the flag setting is changed in steps S101 and S102, and thus the process can get out of the loop of steps S101 to S106.

Alternatively, when the determination result is YES in step S106, that is, when the “cancellation” button is pressed down by the user, the process proceeds to step S107 to get out of the loop. In this case, the consumables may not be actually replaced.

In step S107, the flag F is set such that the relation of F=0 is satisfied. When F=0 the error display is not shown.

In step S108, the second warning display such as the message “Please replace consumables” is shown in the operation panel unit 150. FIG. 11 is a diagram illustrating a display example of the second warning display in the operation panel unit 150 of the image outputting apparatus (the multi-function apparatus) 100 according to this embodiment of the invention. This warning display is shown together with another message “Printing is possible”. In addition, this warning display is configured to typically appear together with the message “Printing is possible”.

Subsequently, in step S109, a sub-routine of an output possibility determining process is executed. When the process returns from this sub-routine, the image outputting process ends in step S111.

Next, the sub-routines of the flowchart of a main routine of the image outputting process described above will be described. FIG. 5 is a flowchart illustrating the sub-routine of the consumables replacement detecting process of the image outputting apparatus according to this embodiment of the invention.

The sub-routine of the consumables replacement detecting process is a process of resetting the counter or the flag when each of the consumables is detected. When the sub-routine of the consumables replacement detecting process starts in step S200, the process proceeds to step S201 to determine whether each of the consumables is replaced in the consumables replacement detecting unit 181 of the consumables managing unit 180.

When the determination result is NO in step S201, the process proceeds to step S203 to return to the main routine. Alternatively, when the determination result is YES in step S201, the process proceeds to step S202 together with the replacement of the consumables to reset the counters M and N and the flag F so as to satisfy the relation of M=0, the relation of N=0, and the relation of F=0, respectively. Subsequently, the process proceeds to return to step S203.

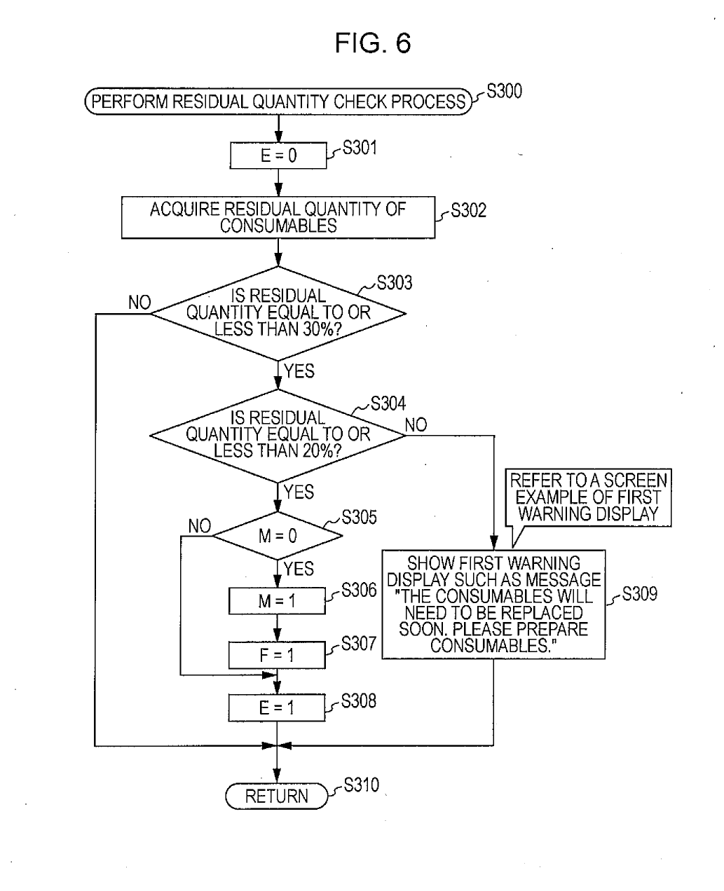

Next, the sub-routine of the residual quantity check process in step S102 will be described. FIG. 6 is a flowchart illustrating the sub-routine of the residual quantity check process of the image outputting apparatus according to this embodiment of the invention. In the following sub-routine, it is assumed that an image forming material such as toner is used for the residual quantity of consumables, but the consumables such as the photosensitive member can also use the flowchart shown in FIG. 6. When the flowchart is applied to the consumables such as the photosensitive member of which an endurance period is determined, the calculation of the endurance expectancy by the consumables endurance expectancy calculating unit 183 can be performed instead of the detection of the residual quantity by the consumables residual quantity detecting unit 182. In additions “the residual quantity” is substituted by “the endurance expectancy”. In the flowchart shown in FIG. 6, reference numerical values such as the residual quantity of 30% or the residual quantity of 20% are exemplified, but these numerical values are just examples. The reference numerical values can be changed in each of consumables.

In the flowchart shown in FIG. 6, when the sub-routine of the residual quantity check process starts in step S300, the process proceeds to step S301. First, the flag E is set such that the relation of E=0 is satisfied.

Subsequently, in step S302, the residual quantity (the endurance expectancy) of the consumables is acquired from the consumables residual quantity detecting unit 182 (the consumables endurance expectancy calculating unit 183).

In step S303, it is determined whether the residual quantity of consumables is equal to or less than 30%. When the determination result is NO in step S303, that is, when the residual quantity of the consumables is sufficient, the process proceeds to step S310 to return to the main routine. Alternatively, when the determination result is YES in step S303, the process proceeds to step S304.

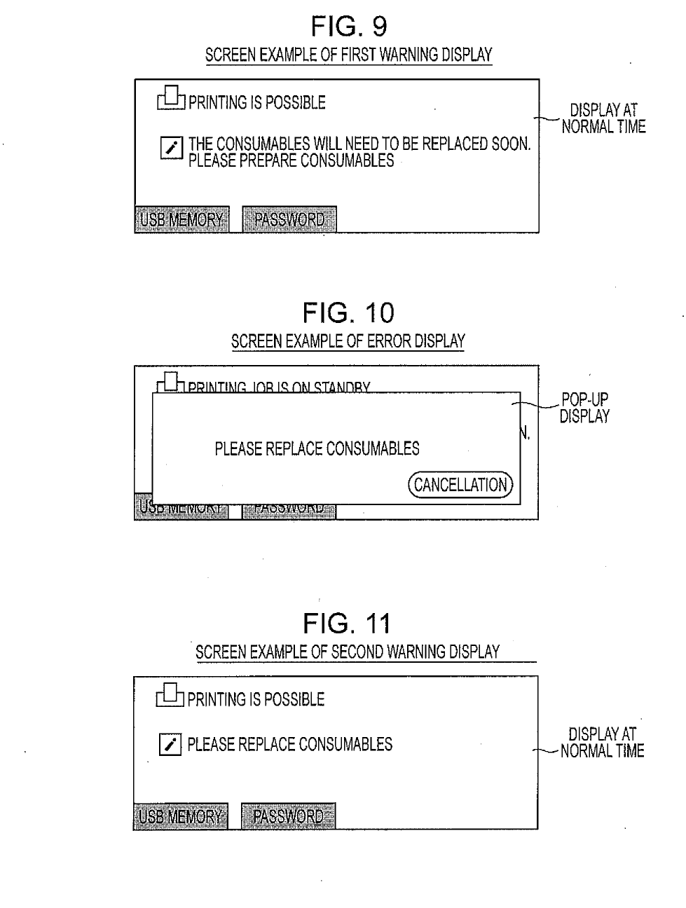

In step S304, it is determined whether the residual quantity of consumables is equal to or less than 20%. When the determination result is NO in step S304, that is, when the residual quantity of the consumables is more than 20% and equal to or less than 30%, the process proceeds to step S309 to show a first warning display such as a message “The consumables will need to be replaced soon. Please prepare consumables” in the operation panel unit 150. FIG. 9 is a diagram illustrating a display example of the first warning display in the operation panel unit 150 of the image outputting apparatus (the multi-function apparatus) 100 according to this embodiment of the invention. In this embodiment, when the residual quantity of the consumables is more than 20% and equal to or less than 30%, this display prompts the user to prepare the consumables.

When the determination result is NO in step S304, that is, when the residual quantity of the consumables is equal to or less than 20%, it is determined whether the relation of M=0 is satisfied in step S305. This step is a step of determining whether the residual quantity of consumables is equal to or less than 20% for the first time after the consumables is set. When the residual quantity of the consumables is equal to or less than 20% for the first time, the relation of M=0 is satisfied. Therefore, since the determination result is YES, the process proceeds to step S306. Alternatively, when the residual quantity of the consumables is equal to or less than 20% two or more times, a relation of M=1 is satisfied. Therefore, since the determination result is NO, the process proceeds to step S308.

In step S306, the counter M is set such that the relation of M=1 is satisfied. The counter M is a counter for counting the number of times the error display is shown.

In step S307, the flag F is set such that a relation of F=1 is satisfied. This setting is performed to make the error display in the operation panel unit 150.

In step S308, the flag E is set such that a relation of E=1 is satisfied. The relation of E=1 represents that the residual quantity of the consumables is equal to or less than 20%.

The process returns to the main routine in step S310.

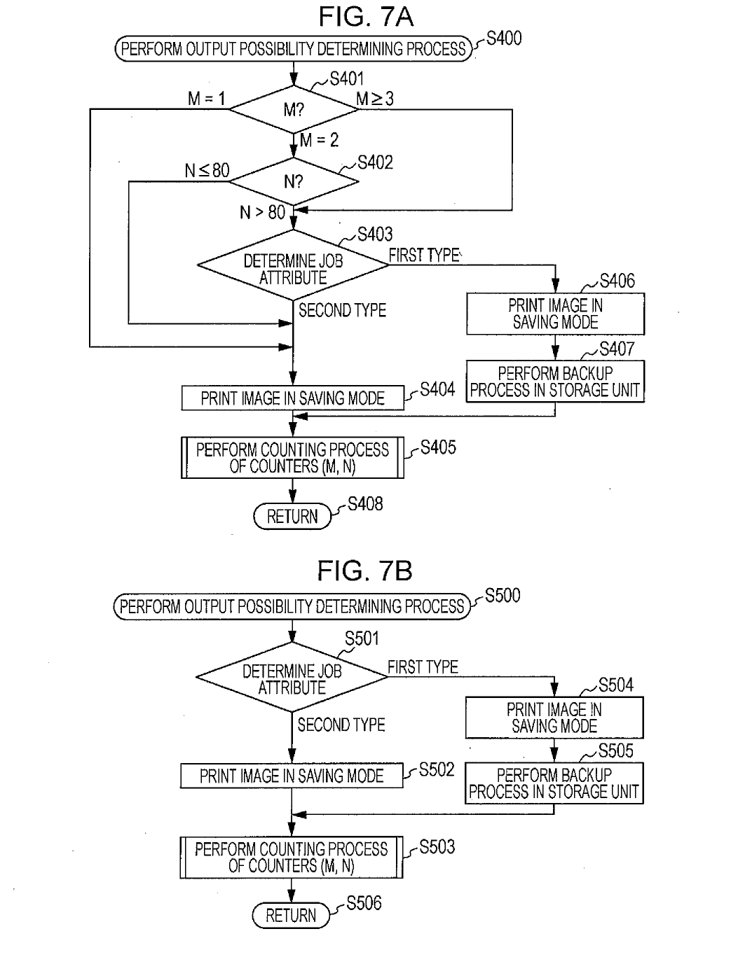

Next, the sub-routine of the output possibility determining process in step S109 will be described. FIGS. 7A and 7B are flowcharts illustrating a sub-routine of an output possibility determining process of the image outputting apparatus according to this embodiment of the invention. FIG. 7A shows an example in which the output possibility determining process is performed in detail on the basis of values of counters M and N. FIG. 7B shows an example when the output possibility determining process is performed without using the values of the counters.

The flowchart shown in FIG. 7A will be described first. In the flowchart shown in FIG. 7A, when the sub-routine of the output possibility determining process starts in step S400, the process then proceeds to step S401 to determine the value of the counter M. When it is determined that the relation of M=1 is satisfied, that is, when the error display is shown for the first time, the process proceeds to step S404. Alternatively, when it is determined that the relation of M=2 is satisfied, that is, when the error display is shown for the second time, the process proceeds to step S402. Alternatively, when it is determined that the relation of M=3 is satisfied, that is, when the error display is shown for the third time or more, the process proceeds to step S403.

In step S402, the value of the counter N is determined. When the value of the counter N is equal to or less than 80, the process proceeds to step S404. Alternatively, when it is determined that the value of the counter N is larger than 80, the process proceeds to step S403.

In steps S401 and S402 described above, it is determined whether to skip the determination of step S403 depending on the values of the counters (M, N).

In step S403, it is determined whether a job attribute of the print output job belongs to a first type of attribute or a second type of attribute. Here, the first type of job attribute is an attribute contained in the print output job which is guessed to be an important job and the second type of job attribute is an attribute contained in the print output job which is guessed to be an unimportant job. These first and second kinds of job attributes are not clearly defined, but the first and second kinds of job attributes can be classified in a manner of an example described below. However, the invention is not limited to the example described below.

When it is determined that the job attribute is the first type of job attribute by the determination of step S403, the process proceeds to step S406. In step S406, the image outputting process is performed to output a print result in a saving mode. Subsequently, in step S407, a backup process of storing the print output job in the storage unit 190 is performed.

Here, when it is assumed that the print output job is associated with the output of the facsimile reception data, this process controls a so-called data backup. Therefore, even when the low quality printing process is performed due to the insufficient quantity of the consumables and thus the print result cannot be read, the printing process can be performed again on the basis of the backup data. Accordingly, it is possible to prevent a problem that the facsimile transmission has to be requested again by contacting the sender.

Alternatively, when it is determined by step S403 that the job attribute is the second type of job attribute, the process proceeds to step S404 to print the image in the saving mode. Subsequently, in step S405, the sub-routine of the counting process of the counter (M, N) is carried out, the sub-routine ends in step S408, and the process returns to the main routine.

In the main routine, the image output in “the normal mode” has been described and the image output in “the saving mode” in step S404 has been described. Now, the respective modes will be described. The image outputting apparatus according to the invention includes a mode for performing image output while saving the consumption of consumables more than in normal image output. The mode for performing the image output is “the saving model.” A mode for performing the normal image output with sufficient consumables is “the normal mode”. Known techniques can be used for the print output of “the normal model” and “the saving model”. When the image output of “the saving mode” cannot be performed, the normal image output may be performed. In addition, when the saving mode cannot be set depending on the kinds of consumables, the image output may be performed in the normal mode.

Next, the flow chart shown in FIG. 73 will be described. A case where the output possibility determining process is performed without using the values of the counters (M, N) is shown. In the flowchart shown in FIG. 7B, when the sub-routine of the output possibility determining process starts in step S500, the job attribute of the print output job is then determined in step S501.

When it is determined in step SS01 that the job attribute of the print output job is the first type of attribute, the process proceeds to step S504. Alternatively, when it is determined that the job attribute of the print output job is the second type of attribute, the process proceeds to step S502. In step S504, the image outputting process is performed in the saving mode to output the print result. Subsequently, in step S505, a backup process of storing the printing outputting job in the storage unit 190 is performed.

In step S502, the image outputting apparatus performs the image outputting process in the saving mode.

In step S503, the sub-routine of the counting process of the counters (M, N) is performed. In step S506, the process returns to the main routine.

The so-called data backup is also controlled by the control process performed on the basis of the flowchart shown in FIG. 7B. Therefore, even when the low quality printing process is performed due to the insufficient quantity of the consumables and thus the print result cannot be read, the printing process can be performed again on the basis of the backup data. Accordingly, it is possible to prevent the problem that the facsimile transmission has to be requested again by contacting the sender.

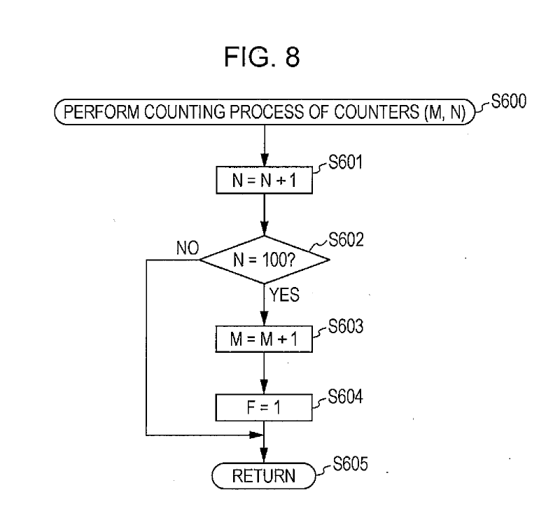

Next, the sub-routine of the counting process of the counters (M, N) will be described. FIG. 8 is a flowchart illustrating the sub-routine of the counting process of the counters (M, N) performed by the image outputting apparatus according to this embodiment of the invention. The counting process is performed whenever the image outputting apparatus (the multi-function apparatus) 100 prints an image on one sheet after the residual quantity of the consumables becomes equal to or less than 20%.

In FIG. 8, when the sub-routine of the counting process of the counters (M, N) in step S600 starts, the counter N then increases by one in step S601.

In step S602, it is determined whether the counter N is equal to 100. When the determination result is NO in step S602, the process proceeds to step S605 to return to the main routine. Alternatively, when the determination result is YES in step S602, the process proceeds to step S603. The counter M increases by one in step S603. In this way, the counter M increases by one whenever the counter N counts to 100. In addition, with the increases in the counter M by one, the flag F is set in step S604 such that the relation of F=1 is satisfied. By setting the flag F in this manner, the error display is carried out. In step S605, the process returns to the main routine.

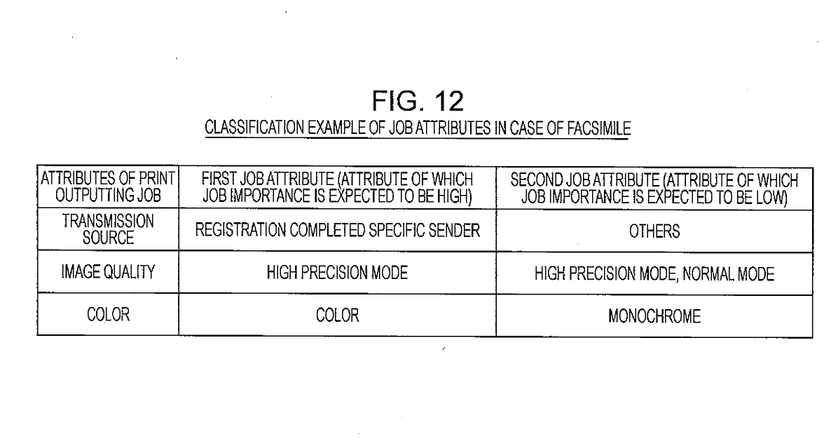

Next, the job attributes of the print output job will be described. FIG. 12 is a diagram illustrating a classification example of the job attributes in the image outputting apparatus (the multi-function apparatus) 100 according to this embodiment of the invention. FIG. 12 is the diagram illustrating the example of the job attribute when the image outputting apparatus (the multi-function apparatus) 100 is used as a facsimile apparatus.

As described above, the job attribute is contained in the print output job. The job attributes are classified into the first type of attribute and the second type of attribute. The first type of job attribute is an attribute contained in the print output job which is guessed to be an important job and the second type of job attribute is an attribute contained in the print output job which is guessed to be an unimportant job.

When the image outputting apparatus (the multi-function apparatus) 100 is used as the facsimile apparatus, as shown in FIG. 12, the first and second types of job attributes can be distinguished by an attribute associated with the sender of the job outputting job, an attribute associated with an image quality of the print output job, and an attribute associated with a color of the print output job. In addition, when the first and second types of job attributes are distinguished, one attribute or a combination of the attributes may be used.

Next, another embodiment of the invention will be described. In this embodiment, the configuration of the image outputting apparatus is different from that of the above-described embodiment. In addition, in this embodiment, the sub-routine of the output possibility determining process in step S109 is different from that of the above-described embodiment. Hereinafter, these differences will be mainly described.

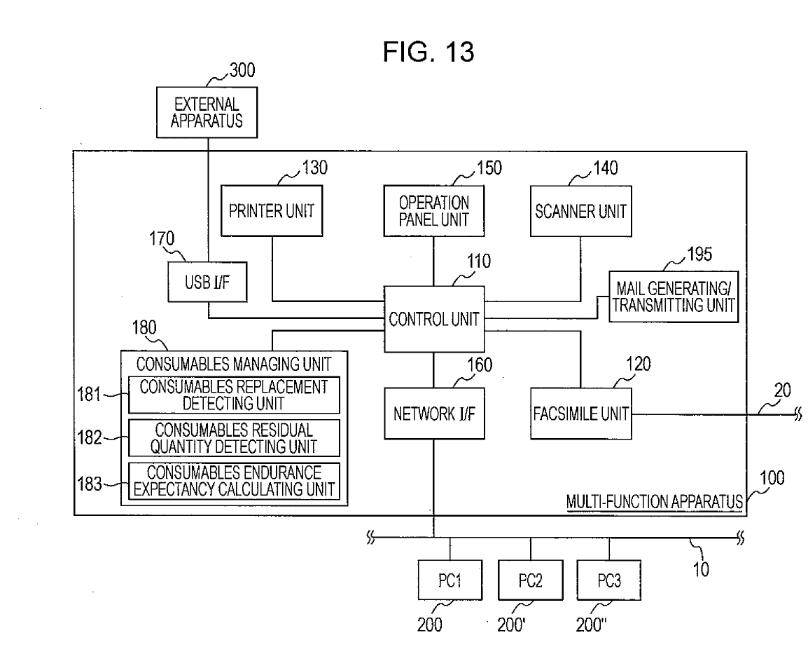

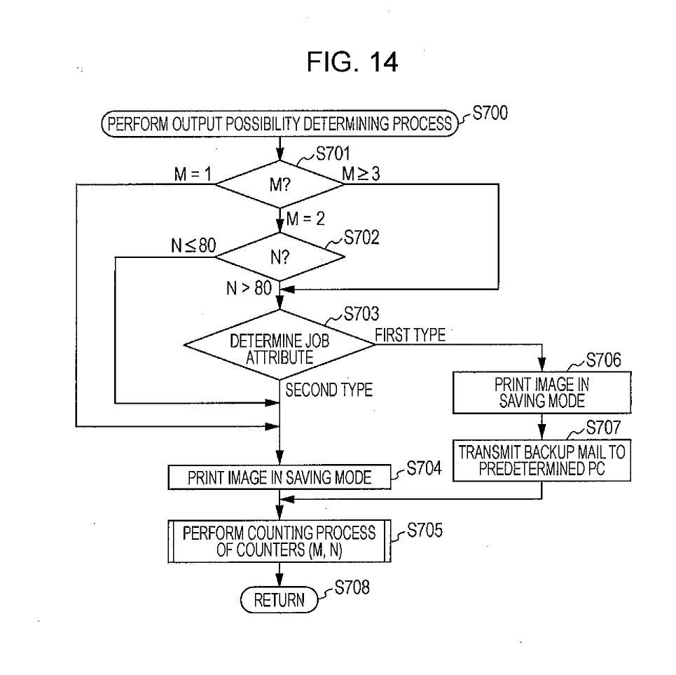

FIG. 13 is a diagram illustrating the system configuration of an image outputting apparatus (multi-function apparatus) and the peripherals according to another embodiment of the invention. FIG. 14 is a flowchart illustrating a sub-routine of an output possibility determining process of the image outputting apparatus according to the another embodiment of the invention.

Points of difference between the system configuration of FIG. 13 and the system configuration of the above-described embodiment will be described. In the above-described embodiment, since the storage unit 190 is provided, the print output job such as the facsimile reception data is not directly backed up. On the contrary, in this embodiment, a mail generating/transmitting unit 195 is provided. The mail generating/transmitting unit 195 converts the print output job such as the facsimile reception data into PDF data or the like, adds the converted PDF data to an electronic mail, and transmits the electronic mail to the predetermined personal computers 200, 200′, and 200″, so as to indirectly back up the facsimile reception data.

A point of difference in the sub-routine of the output possibility determining process performed in this manner will be described. The point of difference between the sub-routine of the output possibility determining process according to this embodiment and the sub-routine of the output possibility determining process according to the above-described embodiment is in the subsequent steps after it is determined that the job attribute of the print output job belongs to the first kind of job attribute in step S703.

When it is determined that the job attribute belongs to the first kind of job attribute in step S703, the process then proceeds to step S706. In step S706, the image outputting process in the saving mode is performed to output a print result. Subsequently, in step S707, the mail generating/transmitting unit 195 converts the print output job such as the facsimile reception data into PDF data or the like, added the converted PDF data to an electronic mail, and transmits the backup mail to the predetermined personal computers 200, 200′, and 200″.

In this embodiment, the backup is controlled by transmitting the backup mail to the predetermined personal computers. Therefore, even when the low quality printing process is performed due to the insufficient quantity of the consumables and thus the print result cannot be read, the printing process can be performed again on the basis of the backup data. Accordingly, it is possible to prevent the problem that the facsimile transmission has to be requested again by contacting the sender.

The various embodiments have been described, but embodiments formed by an arbitrary combination of the above embodiments are also within the scope of the invention.

In the image outputting apparatus according to the invention, when the consumables residual quantity detecting unit detects that the residual quantity of the consumables is equal to or less than the predetermined quantity or when the consumables endurance expectancy calculating unit detects that the endurance expectancy of the consumables is equal to or less than the predetermined endurance expectancy, the so-called data backup is carried out for the print output job which is determined to be important by a job attribute determining unit, by performing the print output while storing the print output job data or by performing the print output while transmitting the data associated with the print output job by the electronic mail by the mail transmitting unit. Accordingly, even when the low quality printing process is performed due to the insufficient quantity of the consumables and thus the print result cannot be read, it is possible to again perform the printing process on the basis of the backup data and prevent the problem that the facsimile transmission has to be requested again by contacting the sender.

The entire disclosure of Japanese Patent Application No. 2008-190461, filed Jul. 24, 2008 is expressly incorporated by reference herein.

What is claimed is:

1. An image outputting apparatus comprising:
a consumables residual quantity detecting unit which detects a residual quantity of consumables;
a job attribute determining unit which determines a job attribute of a print output job; and
an output availability determining unit which determines whether a print output is available,
wherein the output availability determining unit performs a first determining process of determining whether to perform only the print output or to perform the print output while storing the print output job data in accordance with the job attribute determined by the job attribute determining unit, when the consumables residual quantity detecting unit detects that the residual quantity of the consumables is equal to or less than a predetermined quantity.

2. The image outputting apparatus according to claim 1, further comprising:
a mail transmitting unit which appends data associated with the print output job to a mail and transmits the mail,
wherein the output availability determining unit performs a second determining process of determining whether to perform only the print output or to perform the print output while transmitting the mail having the data associated with the print output job by the mail transmitting unit in accordance with the job attribute determined by the job attribute determining unit, when the consumables residual quantity detecting unit detects that the residual quantity of the consumables is equal to or less than the predetermined quantity.

3. The image outputting apparatus according to claim 1, further comprising:
a consumables endurance expectancy calculating unit which calculates an endurance expectancy of consumables,
wherein the output availability determining unit performs a third determining process of determining whether to perform only the print output or to perform the print output while storing the print output job data in accordance with the job attribute determined by the job attribute determining unit, when the consumables endurance expectancy calculating unit detects that the endurance expectancy of the consumables is equal to or less than a predetermined expectancy.

4. The image outputting apparatus according to claim 3, wherein the output availability determining unit performs a fourth determining process of determining whether to perform only the print output or to perform the print output while transmitting the mail having the data associated with the print output job by the mail transmitting unit in accordance with the job attribute determined by the job attribute determining unit, when the consumables endurance expectancy calculating unit detects that the endurance expectancy of the consumables is equal to or less than the predetermined expectancy.

5. The image outputting apparatus according to claim 1, further comprising:
a print output counting unit which counts the print output,
wherein the output availability determining unit performs the first determining process in accordance with the result counted by the print output counting unit and the job attribute determined by the job attribute determining unit.

6. The image outputting apparatus according to claim 1, wherein the job attribute determining unit makes the determination in accordance with one or a combination of an attribute associated with the sender of the print output job, an attribute associated with an image quality of the print output job, and an attribute associated with a color of the print output job.
